(19) United States
(12) Patent Application Publication
(10) Pub. No.: US 2026/0319978 A1
(43) Pub. Date: Oct. 15, 2026

(54) WRITE DATA COMMUNICATION

(71) Applicant: Rambus Inc., San Jose, CA (US)

(72) Inventors: Michael Raymond MILLER, Raleigh, NC (US); Evan Lawrence ERICKSON, Chapel Hill, NC (US)

(21) Appl. No.: 19/467,563

(22) Filed: Feb. 2, 2026

Related U.S. Application Data
(60) Provisional application No. 63/757,037, filed on Feb. 11, 2025.

(51) Int. Cl. G06F 13/16; G06F 13/42

(52) U.S. Cl. CPC G06F 13/1673; G06F 13/1689; G06F 13/4282

(57) ABSTRACT

Communication of commands/addresses and data between a memory controller and a buffer device is via two unidirectional high-speed serial links. The buffer device serializes and deserializes commands, addresses, and data for communication between the memory controller and memory devices. The buffer device also includes a write data buffer. Commands received by the buffer device include commands to load and unload entries in the buffer device's write data buffer. Multiple load write data buffer commands received in a non-contiguous manner result in receiving and loading data into an entry of the buffer's write data in a time non-contiguous manner. Once an entry is fully loaded with data from the non-contiguous buffer load commands, the data may be transmitted, via the memory channel, to the memory devices of the component in association with a write command.

### BRIEF DESCRIPTION OF THE DRAWINGS

FIG. 1 is a block diagram illustrating a memory system.

FIGS. 2A-2F are diagrams illustrating example command/address and data communication.

FIG. 3 is a flow diagram illustrating example write data coalescing.

FIG. 4 is a flow diagram illustrating an example contiguous series of write commands and write data.

FIG. 5 is a flow diagram illustrating example opportunistic write data communication.

FIG. 6 is a flow diagram illustrating example mixed bypassed and buffered write data communication.

FIG. 7 is a flowchart illustrating a method of operating a buffer device.

FIG. 8 is a flowchart illustrating a method of operating a controller.

FIG. 9 is a flowchart illustrating a method of loading and unloading a write data buffer.

FIG. 10 is a flowchart illustrating a method of bypassing a write data buffer.

FIG. 11 is a flowchart illustrating a method of communicating mixing bypassed and buffered write data.

FIG. 12 is a flowchart illustrating a method of providing write commands and associated write data to a plurality of memory devices.

FIG. 13 is a block diagram of a processing system.

### DETAILED DESCRIPTION OF THE EMBODIMENTS

In an embodiment, a memory component (e.g., memory device stack, memory module, etc.) is controlled by a memory controller having a write data buffer. Communication of commands/addresses and data between the memory controller and the serial buffer device is via two unidirectional high-speed serial links (i.e., one link for controller to buffer communication and one link for buffer to controller communication) coupled to a serial buffer device of the memory component. The serial buffer device serializes and deserializes commands, addresses, and data for communication between the memory controller and the memory devices of the memory component. The serial buffer device may also translate the serial commands received via the controller to buffer link into parallel commands, addresses, and data that are compatible with a memory channel (e.g., DDR5 memory channel) having the memory devices of the memory component.

In an embodiment, the serial buffer device also includes a write data buffer. The write data buffer of the serial buffer device may have the same capacity and configuration (e.g., number of entries, addressing of entries, etc.) as the memory controller's write data buffer. In an embodiment, the serial commands received by the serial buffer device include commands to load and unload entries in the serial buffer device's write data buffer. A single command to load an entry in the serial buffer device's write data buffer may only load a specified portion of an entry. Thus, multiple load write data buffer commands received in a non-contiguous manner may result in receiving and loading data into an entry of the serial buffer's write data in a non-contiguous manner (i.e., other commands and data may be communicated via the serial links in between load write data buffer commands directed to that entry). Once this entry is fully loaded (or, in an embodiment, partially loaded) with data from the non-contiguous load commands, the data may be transmitted, via the memory channel, to the memory devices of the component in association with a write command (which is based on a write command received via the controller to buffer serial link).

The descriptions and embodiments disclosed herein are made primarily with references to DRAM devices and DRAM memory arrays. This, however, should be understood to be a first example due at least to the widespread adoption of DRAM technology. It should be understood that other memory technologies may also benefit from the methods and/or apparatus described herein. These memory technologies include, but are not limited to static random access memory (SRAM), non-volatile memory (such as flash), conductive bridging random access memory (CBRAM—a.k.a., programmable metallization cell—PMC), resistive random access memory (a.k.a., RRAM or ReRAM), magnetoresistive random-access memory (MRAM), Spin-Torque Transfer (STT-MRAM), phase change memory (PCM), and the like, and/or combinations thereof. Accordingly, it should be understood that in the disclosures and/or descriptions given herein, these aforementioned technologies may be substituted for, included with, and/or encompassed within, the references to DRAM, DRAM devices, and/or DRAM arrays made herein.

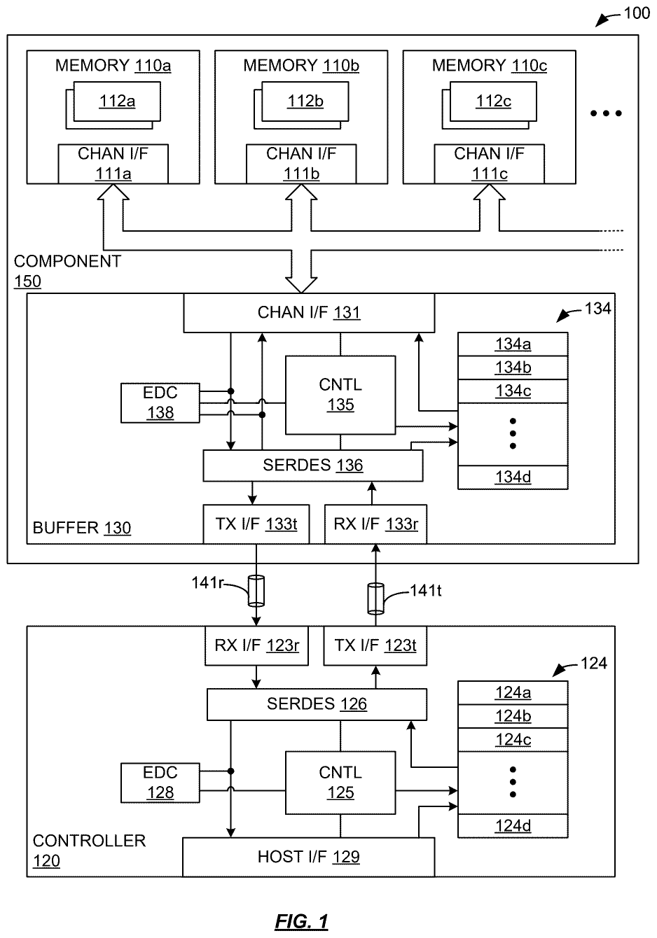

FIG. 1 is a block diagram illustrating a memory system. In FIG. 1, memory system 100 comprises controller 120, transmit serial link 141t, receive serial link 141r, and memory component 150. It should be understood from FIG. 1, that the labels of “transmit” and “receive” are arbitrarily selected with respect to serial transmit link 141t and serial receive link 141r as being from the perspective of controller 120 and are made only for the purposes of indicating the directions of data flow. Thus, it should also be understood that from the perspective of memory component 150, memory component 150 transmits via serial receive link 141r and receives via serial transmit link 141t.

Memory component 150 includes memory device 110a-110c and buffer device 130. Controller 120, memory devices 110a-110c, and buffer device 130 may be one or more integrated circuit type devices, such as are commonly referred to as “chips”. A memory controller, such as controller 120, manages the flow of data going to and from memory devices, and/or memory components such as memory modules and/or memory device stacks (e.g., High Bandwidth memory-HBM). Memory devices 110a-110c may be standalone devices, or may be a component of a memory module such as a DIMM module used in servers. In an embodiment, memory devices 110a-110c may be devices that adhere to, or are compatible with, a dynamic random access memory (DRAM) specification. In an embodiment, memory devices 110a-110c may be, or comprise, a device that is or includes other memory device technologies and/or specifications. A memory controller can be a separate, standalone chip, or integrated into another chip. For example, a memory controller 120 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

Buffer device 130 includes memory channel interface 131, serial transmit interface 133t, serial receive interface 133r, write data buffer circuitry 134, control circuitry 135, sterilizer/deserializer (SERDES) circuitry 136, and error detection correction (EDC) circuitry 138. Write data buffer circuitry 134 includes write data buffer entries 134a-134d.

Serial receive interface 133r is operatively coupled with SERDES circuitry 136 and serial link 141t. Serial receive interface 133r is operatively coupled to SERDES circuitry 136 to at least receive serial communication via serial link 141t that includes commands, addresses, and data from controller 120. Serial receive interface 133r at least couples these commands, addresses, and data to SERDES circuitry 136. Serial transmit interface 133t is operatively coupled to SERDES circuitry 136 and serial link 141r. Serial transmit interface 133t is operatively coupled to SERDES circuitry 136 to at least transmit serial communication to controller 120 via serial link 141t that includes data from memory devices 110a-110c.

SERDES circuitry 136 is also operatively coupled with channel interface 131, write data buffer circuitry 134, control circuitry 135, and EDC circuitry 138. SERDES circuitry 136 at least receives and deserializes serial communication from receive interface 133r and, under the control of control circuitry 135, operatively couples deserialized commands, addresses, and/or data to one or more of channel interface 131, write data buffer circuitry 134, control circuitry 135, and/or EDC circuitry 138. SERDES circuitry 136 also at least receives and serializes parallel communication from channel interface 131 and/or EDC circuitry 138 and, under the control of control circuitry 135, operatively couples serialized data to transmit interface 133t for communication to controller 120 via serial link 141r.

Memory devices 110a-110c respectively include channel interfaces 111a-111c and memory arrays 112a-112c. In an embodiment, memory arrays 112a-112c are dynamic random access memory (DRAM) arrays. Channel interface 131 of buffer device 130 is operatively coupled with channel interfaces 111a-111c of memory devices 110a-110c. In an embodiment, channel interface 131 of buffer device 130 and channel interface 111a-111c of memory device 110a-110c implement a memory device interface standard such as DDR5 and/or HBM having command, address, and data transfer functions.

Controller 120 includes serial transmit interface 123t, serial receive interface 123r, write buffer circuitry 124, control circuitry 125, SERDES circuitry 126, EDC circuitry 128, and host interface circuitry 129. Write buffer circuitry 124 include write data entries 124a-124d. In an embodiment, write buffer circuitry 124 and/or write data entries 124a-124d respectively have the same size and/or addressing as write data buffer circuitry 134 and/or write data entries 134a-123d.

Serial receive interface 123r is operatively coupled with SERDES circuitry 126 and serial link 141r. Serial receive interface 123r is operatively coupled to SERDES circuitry 126 to at least receive serial communication via serial link 141t that includes data from memory devices 110a-110c. Serial receive interface 123r at least couples this data to SERDES circuitry 126. Serial transmit interface 123t is operatively coupled to SERDES circuitry 136 and serial link 141t. Serial transmit interface 123t is operatively coupled to SERDES circuitry 126 to at least transmit serial communication to memory component 150 (and serial receive interface 133r, in particular) via serial link 141t that includes commands, addresses, and data that are based on commands, addresses and/or data received from a host via host interface circuitry 129.

SERDES circuitry 126 is also operatively coupled with host interface circuitry 129, write buffer circuitry 124, control circuitry 125, and EDC circuitry 128. SERDES circuitry 126 at least receives and deserializes serial communication from receive interface 123r and, under the control of control circuitry 125, operatively couples deserialized data to one or more of host interface circuitry 129, control circuitry 125, and/or EDC circuitry 128. SERDES circuitry 126 also at least receives and serializes parallel communication based on communication from host interface circuitry 129, write buffer circuitry 124, and/or EDC circuitry 128 and, under the control of control circuitry 125, operatively couples serialized data to transmit interface 123t for communication to memory component 150 via serial link 141t.

In an embodiment, controller 120 may transmit, via serial link 141t, write data to be stored in an addressed entry 134a-134d of write data buffer circuitry 134 using multiple, time non-contiguous, transfers of data via serial link 141t for storage in an entry of write data buffer circuitry 134 (e.g. buffer entry 134b). Accordingly, the write data transmitted and stored for each of the multiple, time non-contiguous, transfers of data via serial link 141t in the addressed entry may be only a portion of the data required for a write to memory devices 110a-110c.

For example, if write commands/transactions with memory devices 110a-110c via channel interface 131 transfer 64 bytes of data to memory devices 110 a-110c to be written to memory devices 110a-110c, using a first command to buffer device 130 (e.g., a first buffer load command with associated entry 134a-134d address), controller 120 may transmit less than the full 64 bytes required for a write command via channel interface 131 (e.g., first portion of 24 bytes, 32 bytes, 56 bytes, etc.) for storage in an entry 134 a-134d of write data buffer circuitry 134. Later, possibly after intervening commands, addresses, and/or data have been transmitted via serial link 141t, using a second command to buffer device 130 (e.g., a second buffer load command with associated entry 134a-134d address), controller 120 may transmit all or part of the remaining 64 bytes required for a write command via channel interface 131 (e.g., a second portion respectively of 40 bytes, 32 bytes, 8 bytes, etc.) for storage in an entry 134 a-134d of write data buffer circuitry 134. Once all of the 64 bytes have been received and stored in the addressed entry 134a-134d of write data buffer circuitry 134 controller 120 may transmit (or may have previously transmitted depending upon various timing factors such a write command to write data latency of memory device 110a-110c) a command (e.g., buffer unload command with associated entry 134 a-134d address) that results in the full 64 bytes from the addressed entry 134a-134d being transmitted as write data associated with a write command to memory devices 110a-110c.

In an embodiment, controller 120 may transmit, via serial link 141t, write data that is not to be stored in write data buffer circuitry 134. In other words, for example, controller 120 may transmit, via serial link 141t, a command to bypass write data buffer circuitry 134 and send deserialized write data directly to channel interface 131. For example, for write commands/transactions with memory devices 110a-110c via channel interface 131 that transfer 64 bytes of data to memory devices 110 a-110c to be written to memory devices 110 a-110c, controller 120 may transmit a write command and associated 64 bytes of write data, as one burst of write data (or, in an another example, one burst of command and a second burst of 64 bytes of write data), to serial buffer 130. This single, contiguous burst of write data may be transmitted by buffer device 130, via channel interface 131, without first being stored in write data buffer circuitry 134.

In an embodiment, controller 120 may transmit, via serial link 141t, a portion of write data that is to be stored in write data buffer circuitry 134, and a portion of data that is not to be stored in write data buffer circuitry 134. In other words, for example, controller 120 may transmit less than the full 64 bytes required for a write command via channel interface 131 (e.g., a first portion of 24 bytes, 32 bytes, 56 bytes, etc.) for storage in an entry 134 a-134d of write data buffer circuitry 134. Later, possibly after intervening commands, addresses, and/or data have been transmitted via serial link 141t, using a second command to buffer device 130, controller 120 may transmit the remaining bytes of the 64 bytes required for a write command via channel interface 131 (e.g., a second portion respectively of 40 bytes, 32 bytes, 8 bytes, etc.) to bypass write data buffer circuitry 134 and be combined with the first portion from write data buffer circuitry 134 for transmission to memory devices 110a-110c.

As described herein, write data transmitted by controller 120 is coalesced and/or stored in entries 134a-134d of write data buffer circuitry 134. In an embodiment, the particular entry 134a-134d where data transmitted by controller 120 is stored in write data buffer circuitry 134 by buffer device 130 may be based on information in the command (e.g., an entry 134a-134d address/indicator as part of a buffer load command) and/or header associated with the transmitted data. In an embodiment, the particular entry 134a-134d where data transmitted by controller 120 is stored in write data buffer circuitry 134 by buffer device 130 may mimic or mirror the location in write buffer circuitry 124 where that particular entry 124a-124d is/was stored in write buffer 124 of controller 120 (e.g., based on information and/or address from the buffer load command). In an embodiment, the particular entry 134a-134d where data transmitted by controller 120 is stored in write data buffer circuitry 134 by buffer device 130 may be based on the order in which data is transmitted by controller 120 (and received by buffer device 130). Similarly, in an embodiment, the particular entry 134a-134d where data stored in buffer 134 by buffer device 130 is selected for transmission to DRAM devices 110a-110c may be based on the order in which data is transmitted by controller 120 (and received by buffer device 130). In addition, a combination of order of transmission/reception and entry 134a-134d are contemplated for indicating which entry 134a-134d are the target of a buffer load, buffer unload, and/or write command. For example, write data buffer circuitry 134 may function in a first-in first-out (FIFO) manner with a command, mode, and/or entry indicator optionally overriding strict FIFO functionality. The data stored in buffer 134 by buffer device 130 may arrive in a given order, but it should be understood that this order of arrival does not determine the order that is selected for transmission to DRAM devices 110a-110c. The order that entries are transmitted to DRAM devices 110a-110c, which may be different than the order of arrival, may be selected based on such factors as bank conflicts and optimal scheduling, etc.

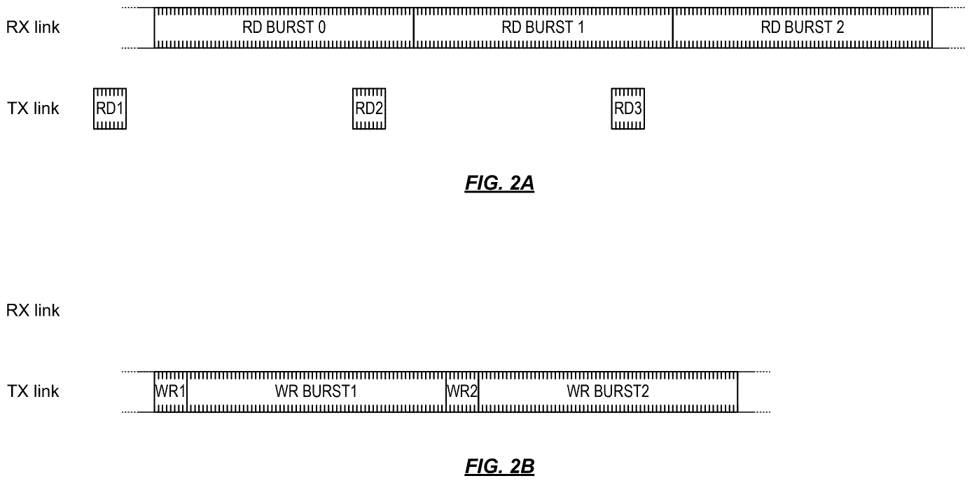

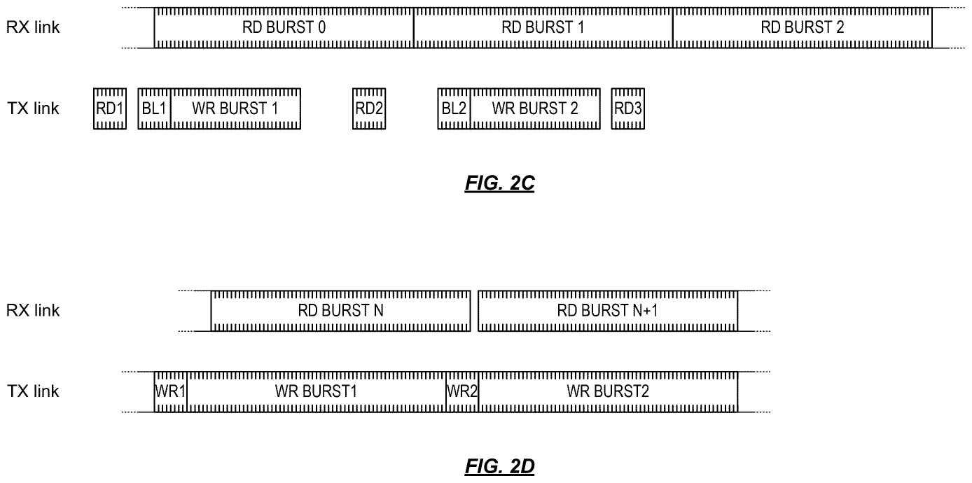

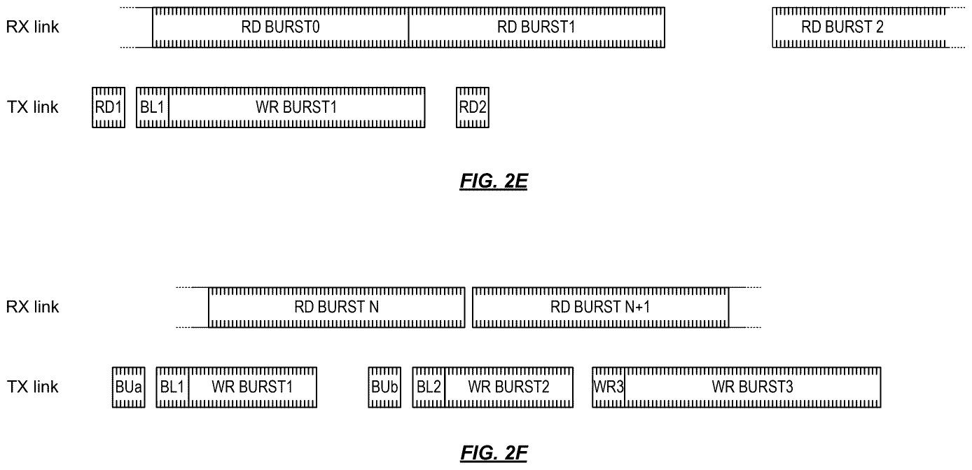

FIGS. 2A-2F are diagrams illustrating example command/address and data communication. In FIGS. 2A-2F, example communication via a serial receive link (RX link—e.g., link 141r) and a transmit link (TX link—e.g., link 141t) are illustrated.

FIG. 2A illustrates an example sequence where, due to successive read commands, the receive link is fully saturated. In FIG. 2A, the communication sequence begins with a first read command (RD1) being communicated via the transmit link. In response to a previous command not shown in FIG. 2A (e.g., RD0) a first read data burst (RD BURST 0) is communicated. At or around a minimum back-to-back read command delay interval after the first read command was communicated (e.g., because the RX link will be communicating the RD BURST 0 data), a second read command (RD2) is communicated via the transmit link. In immediate succession after the communication of the first read data burst and in response to the first read command, a second read data burst (RD BURST 1) is communicated via the receive link. At or around a minimum back-to-back read command delay interval after the second read command was communicated (e.g., because the RX link will be communicating the RD BURST 1 data), a third read command (RD3) is communicated via the transmit link. In immediate succession after the communication of the second read data burst and in response to the second read command, a third read data burst (RD BURST 2) is communicated via the receive link.

FIG. 2B illustrates an example sequence where successive write commands and associated data saturate the transmit link illustrating that some non-data bandwidth (i.e., command bandwidth) occupies some of the overall maximum bandwidth available on the transmit link. In FIG. 2B, the communication sequence begins with a first write command (WR1) being communicated via the transmit link. In immediate succession after the communication of the first write command, a first write data burst is communicated (WR BURST 1) via the transmit link. The first write data burst may or may not be associated with the first write command. In immediate succession after the first write data burst, a second write command (WR2) is communicated via the transmit link. The second write data burst may or may not be associated with the first or second write command. In immediate succession after the communication of the second write command, a second write data burst is communicated (WR BURST 2) via the transmit link. Note that, in FIG. 2B, the total length of one write command and one write data burst (e.g., 72-bytes) is longer than a read data burst (e.g., 64-bytes).

Thus, it should be understood that for the example sequence illustrated in FIG. 2B, the successive write commands WR1 and WR2 occupy some of the communication bandwidth of the transmit link. For example, if it takes 8-bytes to communicate a single write command (e.g., WR1) and the associated data is 64-bytes in size, the communication bandwidth of a sustained continuous stream of write commands may be on the order of 12.5%.

FIG. 2C illustrates an example sequence where, due to successive read commands, the receive link is fully saturated with data and the transmit link is opportunistically communicating write data to be coalesced in the buffer device's write data buffer between the successive read commands. In FIG. 2C, the communication sequence begins with a first read command (RD1) being communicated via the transmit link. In response to a previous command not shown in FIG. 2C (e.g., RD0) a first read data burst (RD BURST 0) is communicated. Before and/or during the communication of the first read data burst, a first buffer load command (BL1) and associated data (WR BURST 1) is communicated via the transmit link. At or around a minimum back-to-back read command delay interval after the first read command was communicated (e.g., because the RX link will be communicating the RD BURST 0 data), a second read command (RD2) is communicated via the transmit link. In immediate succession after the communication of the first read data burst and in response to the first read command, a second read data burst (RD BURST 1) is communicated via the receive link. Before and/or during the communication of the second read data burst, a second buffer load command (BL2) and associated data (WR BURST 2) is communicated via the transmit link. In an example, the first write data burst and the second write data burst comprise enough write data to fill a buffer device (e.g., buffer device 130) write data buffer entry (e.g., one of entries 134a-134d). At or around a minimum back-to-back read command delay interval after the second read command was communicated (e.g., because the RX link will be communicating the RD BURST 1 data), a third read command (RD3) is communicated via the transmit link. In immediate succession after the communication of the second read data burst and in response to the second read command, a third read data burst (RD BURST 2) is communicated via the receive link.

FIG. 2D illustrates an example sequence where successive write commands and associated data saturate the transmit link and the receive link is not fully saturated with data because of the bandwidth occupied on the transmit link by at least the write commands being communicated via the transmit link. In FIG. 2D, the communication sequence begins with a first write command (WR1) being communicated via the transmit link. In immediate succession after the communication of the first write command, a first write data burst is communicated (WR BURST 1) via the transmit link. The first write data burst may or may not be associated with the first write command. In immediate succession after the first write data burst, a second write command (WR2) is communicated via the transmit link. The second write data burst may or may not be associated with the first or second write command. In immediate succession after the communication of the second write command, a second write data burst is communicated (WR BURST 2) via the transmit link. While the write commands and write data bursts are being communicated via the transmit link, the read link may be communicating back to back read data bursts (RD BURST N and RD BURST N+1). However, in FIG. 2D, because the total length of one write command and one write data burst (e.g., 72-bytes) is longer than a read data burst (e.g., 64-bytes), the read data bursts in FIG. 2D are illustrated as not being in immediate succession to each other (although they could be in immediate succession).

Thus, it should be understood that for the example sequence illustrated in FIG. 2D, the successive write commands WR1 and WR2 occupy some of the communication bandwidth of the transmit link. For example, if it takes 8-bytes to communicate a single write command (e.g., WR1) and the associated data is 64-bytes in size, the communication bandwidth of a sustained continuous stream of write commands may be on the order of 12.5%. Note also from the read link in FIG. 2D, since the read link is not used for command transmission, the total length of one read data burst (e.g., 64-bytes) is shorter than a write data burst (e.g., 64-bytes) plus a write command (e.g., 8-bytes). Accordingly, successive and sustained read data bursts need not be immediate succession to each other (although they could be in immediate succession) while write commands and data bursts are being communicated in immediate succession.

FIG. 2E illustrates an example sequence where, due to successive read commands, the receive link is not fully saturated with data and the transmit link is opportunistically sending full blocks of write data without needing to be coalesced in the buffer device's write data buffer. In FIG. 2E, the communication sequence begins with a read command RD1 being communicated via the transmit link. In response to a previous read command (not shown in FIG. 2E—e.g., RD0) a read data burst (RD BURST 0) associated with the previous read command is communicated. Before and/or during the communication of the read data burst (RD BURST 0) associated with the previous read command, a first buffer load command (BL1) and associated complete data block (WR BURST 1) is communicated via the transmit link. In other words, the first write data burst comprises enough write data to fill a buffer device (e.g., buffer device 130) write data buffer entry (e.g., one of entries 134a-134d).

At or around a minimum back-to-back read command delay interval after the previous read command was communicated (e.g., because the RX link will be communicating the RD BURST 0 data), a first read command (RD1) is communicated via the transmit link. In immediate succession after the communication of the read data burst (RD BURST 0) associated with the previous read command, and in response to the first read command, a first read data burst (RD BURST 1) is communicated via the receive link. After the completion of the communication of the first buffer load command (BL1) and associated complete data block (WR BURST 1), a second read command (RD2) is communicated. In response to the second read command, a second read data burst (RD BURST 2) is communicated via the receive link after the communication of the first read data burst.

FIG. 2F illustrates an example sequence where, due to successive buffer unload commands, the transmit link is not fully saturated and is opportunistically communicating write data to be coalesced in the buffer device's write data buffer between the successive buffer unload and/or write commands. In FIG. 2F, the receive link may (or may not) be communicating read data bursts in response to read commands not illustrated in FIG. 2F. In FIG. 2F, the transmit link communication sequence begins with a first buffer unload write command (BUa) being communicated via the transmit link. Because the data to be written to the DRAM devices in response to a buffer unload command is sourced from an entry in the data buffer's write buffer, no data is communicated in association with the first buffer write command. Following the first buffer unload command, a first buffer load command (BL1) and associated data (WR BURST 1) is communicated via the transmit link. At or around a minimum back-to-back write command delay interval after the first buffer unload command was communicated (e.g., because the data associated with the first buffer unload command is being written to the DRAM devices), a second buffer unload command (BUb) is communicated via the transmit link. Following the second buffer unload command, a second buffer load command (BL2) and associated data (WR BURST 2) is communicated via the transmit link. In an embodiment where the minimum back-to-back write command delay interval is less than the amount of time needed to communicate full blocks of write data (e.g., 64 bytes), it should be understood that WR BURST 1 and WR BURST 2 may be less than a full block of data (and/or buffer entry size) and may need to be coalesced with each other or other write data bursts in the buffer device's write data buffer. At or around a minimum back-to-back write command delay interval after the second buffer unload command was communicated (e.g., because the data associated with the second buffer unload command is being written to the DRAM devices), a write command (WR3) and associated write data (WR BURST 3) is communicated via the transmit link. The write data associated with the write command may, in some embodiments, bypass the write data buffer of the buffer device and be sent directly to the DRAM devices as write data without being stored in the write data buffer of the buffer device.

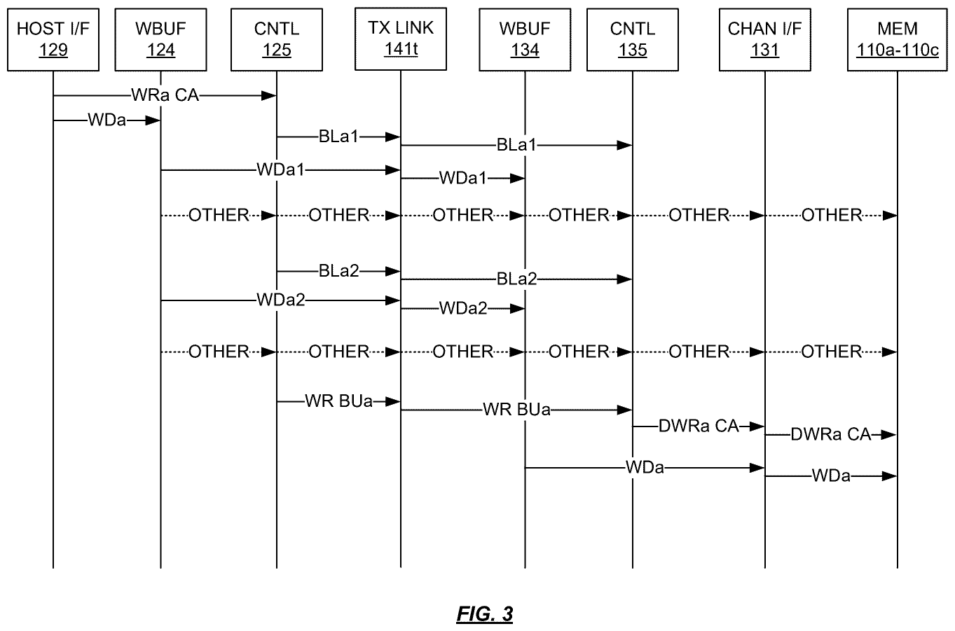

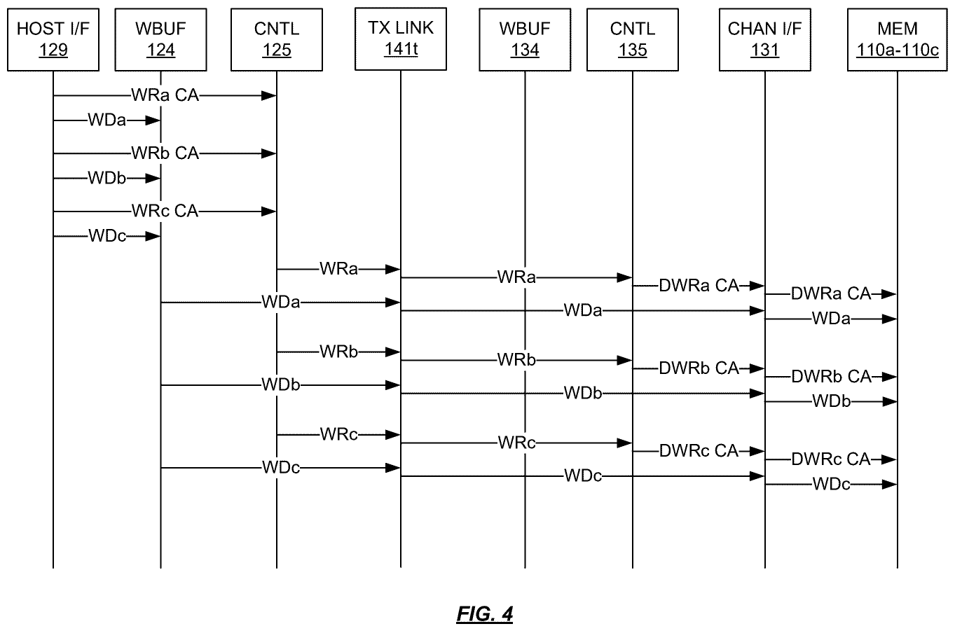

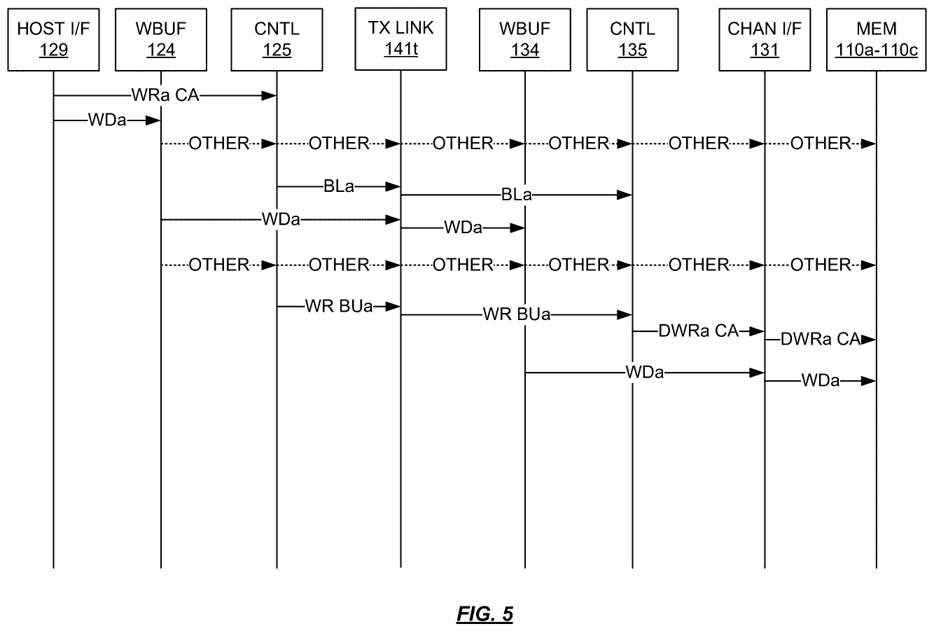

FIG. 3 is a flow diagram illustrating example write data coalescing. Host interface circuitry 129 of controller 120 receives (e.g., from a host) a first write data command and address (WRa CA) to control circuitry that is communicated to control circuitry 125. Host interface circuitry 129 also receives data (WDa) associated with the first write data command that is communicated and stored in write buffer circuitry 124 of controller 120.

Based on the first write data command, control circuitry 125 causes the communication of a first buffer load command (BLa1) via transmit link 141t. The first buffer load command is communicated to control circuitry 135 of buffer device 130. In association with the first buffer load command, a first portion (WDa1) of the received write data is communicated via transmit link 141t. Based on the first buffer load command, the first portion of the write data is communicated and stored in an entry of write data buffer circuitry 134. After communication of the first portion of the write data, other commands and data may be communicated between one or more of write buffer circuitry 124, control circuitry 125, transmit link 141t, write data buffer circuitry 134, control circuitry 135, channel interface 131, and/or memory devices 110a-110c.

Based on the first write data command, control circuitry 125 causes the communication of a second buffer load command (BLa2) via transmit link 141t. The second buffer load command is communicated to control circuitry 135 of buffer device 130. In association with the second buffer load command, a second portion (WDa2) of the received write data is communicated via transmit link 141t. Based on the second buffer load command, the second portion of the write data is communicated and stored in an entry of write data buffer circuitry 134. After communication of the second portion of the write data, other commands and data may be communicated between one or more of write buffer circuitry 124, control circuitry 125, transmit link 141t, write data buffer circuitry 134, control circuitry 135, channel interface 131, and/or memory devices 110a-110c.

Based on the first write data command, control circuitry 125 causes the communication of a write using buffer unload command (WR BUa) via transmit link 141t. The write using buffer unload command is communicated to control circuitry 135 of buffer device 130. Based on the write using buffer unload command, control circuitry 135 communicates a DRAM device write command and address (DWRa CA) to channel interface 131. Also based on the write using buffer unload command, control circuitry 135 causes write data buffer circuitry 134 to communicate the write data (WDa) to channel interface 131. Channel interface 131 communicates the DRAM device write command and the write data, using parallel links, to the memory devices 110a-110c.

Although FIG. 3 depicts certain example orderings of data flows, it should be understood that FIG. 3 and its associated discussion should be interpreted as non-limiting. Other data flow orderings and/or timings are contemplated based on various transactions (e.g., other commands on TX link 141t, data bursts on RX link, etc.) and/or memory timings. For example, the timing relationship between DRAM device write command and address's (DWRa CA) transmission via channel interface 131 and associated write data (WDa) may be based on memory devices 110a-110c write latency specification. Similarly, other commands and/or data may be communicated between commands and data that are illustrated in FIG. 3 as being consecutive. For example, in some embodiments, other commands and/or data may be communicated between, for example, the first buffer load command (BLa1) and its associated first portion (WDa1) write data. However, for the sake of brevity, these optional intervening commands and data have not been illustrated in FIG. 3.

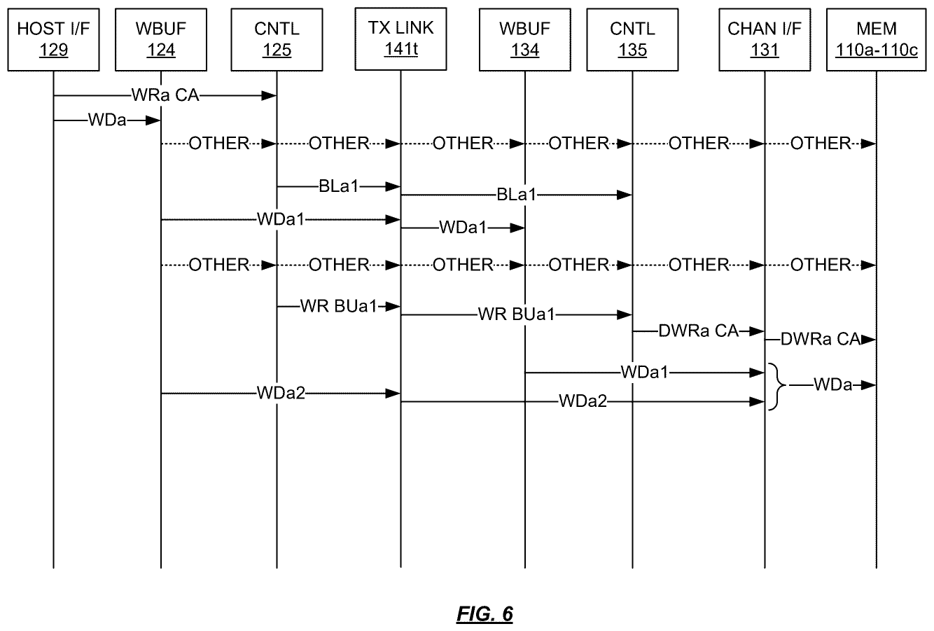

FIG. 4 is a flow diagram illustrating an example contiguous series of write commands and write data. Host interface circuitry 129 of controller 120 receives (e.g., from a host) a series (not necessarily in immediate succession) a first write data command and address (WRa CA), a second write data command and address (WRb CA), and a third write data command and address (WRc CA) to control circuitry that is communicated to control circuitry 125. Host interface circuitry 129 also receives (not necessarily in immediate succession) first, second, and third write data blocks (WDa, WDb, and WDc, respectively) that are respectively associated with the first, second, and third write data commands that are then communicated and stored in write buffer circuitry 124 of controller 120.

Based on the first write data command, control circuitry 125 causes the communication of a first write data command (WRa) via transmit link 141t. The first write data command is communicated to control circuitry 135 of buffer device 130. In association with the first write data command, the first write data block (WDa) is communicated via transmit link 141t. The first write data is not stored in an entry of write data buffer circuitry 134. Based on first write data command, control circuitry 135 communicates a first DRAM device write command and address (DWRa CA) to channel interface 131. Also based on the first write data command, control circuitry 135 causes the first write data block to be communicated directly to channel interface 131. Channel interface 131 communicates the first DRAM device write command and the first write data block, using parallel links, to the memory devices 110a-110c.

Based on the second write data command, control circuitry 125 causes the communication of a second write data command (WRb) via transmit link 141t. The second write data command is communicated to control circuitry 135 of buffer device 130. In association with the second write data command, the second write data block (WDb) is communicated via transmit link 141t. The second write data is not stored in an entry of write data buffer circuitry 134. Based on second write data command, control circuitry 135 communicates a second DRAM device write command and address (DWRb CA) to channel interface 131. Also based on the second write data command, control circuitry 135 causes the second write data block to be communicated directly to channel interface 131. Channel interface 131 communicates the second DRAM device write command and the second write data block, using parallel links, to the memory devices 110a-110c.

Based on the third write data command, control circuitry 125 causes the communication of a third write data command (WRc) via transmit link 141t. The third write data command is communicated to control circuitry 135 of buffer device 130. In association with the third write data command, the third write data block (WDc) is communicated via transmit link 141t. The third write data is not stored in an entry of write data buffer circuitry 134. Based on third write data command, control circuitry 135 communicates a third DRAM device write command and address (DWRc CA) to channel interface 131. Also based on the third write data command, control circuitry 135 causes the third write data block to be communicated directly to channel interface 131. Channel interface 131 communicates the third DRAM device write command and the third write data block, using parallel links, to the memory devices 110a-110c.

Although FIG. 4 depicts certain example orderings of data flows, it should be understood that FIG. 4 and its associated discussion should be interpreted as non-limiting. Other data flow orderings and/or timings are contemplated based on various transactions (e.g., other commands on TX link 141t, data bursts on the RX link, etc.) and/or memory timings. For example, the timing relationship between DRAM device write command and address's (DWRa CA) transmission via channel interface 131 and associated write data (WDa) may be based on memory devices 110a-110c write latency specification. Similarly, other commands and/or data may be communicated between commands and data that are illustrated in FIG. 4 as being consecutive. For example, in some embodiments, other commands and/or data may be communicated between, for example, the first write data command (WRa) and its associated write data (WDa). However, for the sake of brevity, these optional intervening commands and data have not been illustrated in FIG. 4.

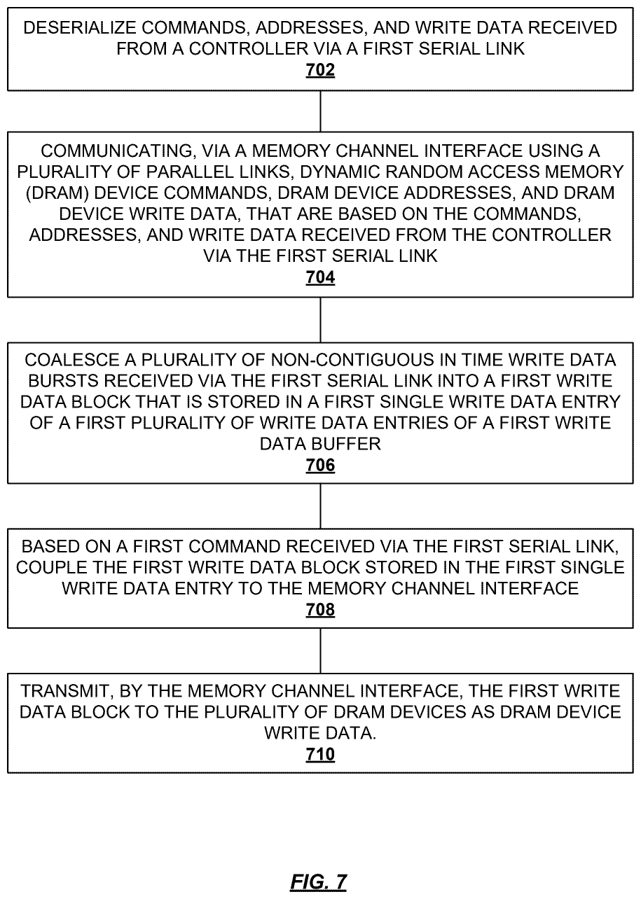

FIG. 5 is a flow diagram illustrating example opportunistic write data communication. Host interface circuitry 129 of controller 120 receives (e.g., from a host) a write data command and address (WRa CA) to control circuitry that is communicated to control circuitry 125. Host interface circuitry 129 also receives data (WDa) associated with the write data command that is communicated and stored in write buffer circuitry 124 of controller 120. After communication of the write data command and write data, other commands and data may be communicated between one or more of write buffer circuitry 124, control circuitry 125, transmit link 141t, write data buffer circuitry 134, control circuitry 135, channel interface 131, and/or memory devices 110a-110c.

Based on the write data command, control circuitry 125 causes the communication of a buffer load command (BLa) via transmit link 141t. The buffer load command is communicated to control circuitry 135 of buffer device 130. In association with the buffer load command, a full block of received write data (WDa) is communicated via transmit link 141t. Based on the buffer load command, the full block of write data is communicated and stored in an entry of write data buffer circuitry 134. After communication of the write data, other commands and data may be communicated between one or more of write buffer circuitry 124, control circuitry 125, transmit link 141t, write data buffer circuitry 134, control circuitry 135, channel interface 131, and/or memory devices 110a-110c.

Based on the write data command, control circuitry 125 causes the communication of a write using buffer unload command (WR BUa) via transmit link 141t. The write using buffer unload command is communicated to control circuitry 135 of buffer device 130. Based on the write using buffer unload command, control circuitry 135 communicates a DRAM device write command and address (DWRa CA) to channel interface 131. Also based on the write using buffer unload command, control circuitry 135 causes write data buffer circuitry 134 to communicate the write data to channel interface 131. Channel interface 131 communicates the DRAM device write command and the write data, using parallel links, to the memory devices 110a-110c.

Although FIG. 5 depicts certain example orderings of data flows, it should be understood that FIG. 5 and its associated discussion should be interpreted as non-limiting. Other data flow orderings and/or timings are contemplated based on various transactions (e.g., other commands on TX link 141t, data bursts on the RX link, etc.) and/or memory timings. For example, the timing relationship between DRAM device write command and address's (DWRa CA) transmission via channel interface 131 and associated write data (WDa) may be based on memory devices 110a-110c write latency specification. Similarly, other commands and/or data may be communicated between commands and data that are illustrated in FIG. 5 as being consecutive. For example, in some embodiments, other commands and/or data may be communicated between, for example, the first the first buffer load command (BLa) and its associated write data (WDa). However, for the sake of brevity, these optional intervening commands and data have not been illustrated in FIG. 5.

FIG. 6 is a flow diagram illustrating example mixed bypassed and buffered write data communication. Host interface circuitry 129 of controller 120 receives (e.g., from a host) a first write data command and address (WRa CA) to control circuitry that is communicated to control circuitry 125. Host interface circuitry 129 also receives data (WDa) associated with the first write data command that is communicated and stored in write buffer circuitry 124 of controller 120. After communication of the first portion of the write data, other commands and data may be communicated between one or more of write buffer circuitry 124, control circuitry 125, transmit link 141t, write data buffer circuitry 134, control circuitry 135, channel interface 131, and/or memory devices 110a-110c.

Based on the first write data command, control circuitry 125 causes the communication of a first buffer load command (BLa1) via transmit link 141t. The first buffer load command is communicated to control circuitry 135 of buffer device 130. In association with the first buffer load command, a first portion (WDa1) of the received write data is communicated via transmit link 141t. Based on the first buffer load command, the first portion of the write data is communicated and stored in an entry of write data buffer circuitry 134. After communication of the first portion of the write data, other commands and data may be communicated between one or more of write buffer circuitry 124, control circuitry 125, transmit link 141t, write data buffer circuitry 134, control circuitry 135, channel interface 131, and/or memory devices 110a-110c.

Based on the write data command, control circuitry 125 causes the communication of a write using buffer unload portion command (WR Bua1) via transmit link 141t. The write using buffer unload portion command is communicated to control circuitry 135 of buffer device 130. Based on the write using buffer unload portion command, control circuitry 135 communicates a DRAM device write command and address (DWRa CA) to channel interface 131. Also based on the write using buffer unload command, control circuitry 135 causes write data buffer circuitry 134 to communicate the first portion of the write data to channel interface 131. Further based on the write data command, control circuitry 125 causes the second portion of the write data (WDa2) to be communicated via transmit link 141t. The second portion of the write data is communicated to channel interface 131 without being stored in write data buffer circuitry 134. Channel interface 131 communicates the DRAM device write command and the two portions of write data, using parallel links, to the memory devices 110a-110c.

Although FIG. 6 depicts certain example orderings of data flows, it should be understood that FIG. 6 and its associated discussion should be interpreted as non-limiting. Other data flow orderings and/or timings are contemplated based on various transactions (e.g., other commands on TX link 141t, data bursts on RX link, etc.) and/or memory timings. For example, the timing relationship between DRAM device write command and address's (DWRa CA) transmission via channel interface 131 and associated write data (WDa) may be based on memory devices 110a-110c write latency specification. Similarly, other commands and/or data may be communicated between commands and data that are illustrated in FIG. 6 as being consecutive. For example, in some embodiments, other commands and/or data may be communicated between, for example, the first buffer load command (BLa1) and its associated first portion (WDa1) write data. However, for the sake of brevity, these optional intervening commands and data have not been illustrated in FIG. 6.

FIG. 7 is a flowchart illustrating a method of operating a buffer device. One or more steps illustrated in FIG. 7 may be performed by, for example, system 100, and/or its components. Commands, addresses, and write data received from a controller via a first serial link are deserialized (702). For example, SERDES circuitry 136 may deserialize commands, addresses and write data received from controller 120 via serial link 141t and couple one or more of the deserialized commands, addresses, and/or data to one or more of channel interface 131, write data buffer circuitry 134, control circuitry 135, and/or EDC circuitry 138.

Via a memory channel interface using a plurality of parallel links, dynamic random access memory (DRAM) device commands, DRAM device addresses, and DRAM device data, that are based on the commands, addresses, and write data received from the controller via the first serial link are communicated (704). For example, channel interface 131 may communicate DRAM device commands, DRAM device addresses, and DRAM device data that are based on the commands, addresses, and write data received from controller 120 via transmit link 141t to memory device 110a-110c.

A plurality of non-contiguous in time write data bursts received via the first serial link are coalesced into a first write data block that is stored in a first single write data entry of a first plurality of write data entries of a first write data buffer (706). For example, buffer device 130 may coalesce a first write data burst (e.g., WDa1 of FIG. 3) with a second write data burst (WDa2 of FIG. 3) into a single write data entry (e.g., write data entry 134b) of write data buffer circuitry 134. Based on a command received via the first serial link, the first write data block stored in the first single write data entry is coupled to the memory channel interface (708). For example, based on a write using buffer unload command (e.g., BUa of FIG. 3) received via transmit link 141t, buffer device 130 may couple the write data stored in the single write data entry (e.g., write data entry 134b) to memory channel interface 131.

By the memory channel interface, the first write data block is transmitted to the plurality of DRAM devices as DRAM write data (710). For example, buffer device 130 may couple the write data from write data buffer circuitry 134 to memory devices 110a-110c via the parallel links of memory channel interface 131.

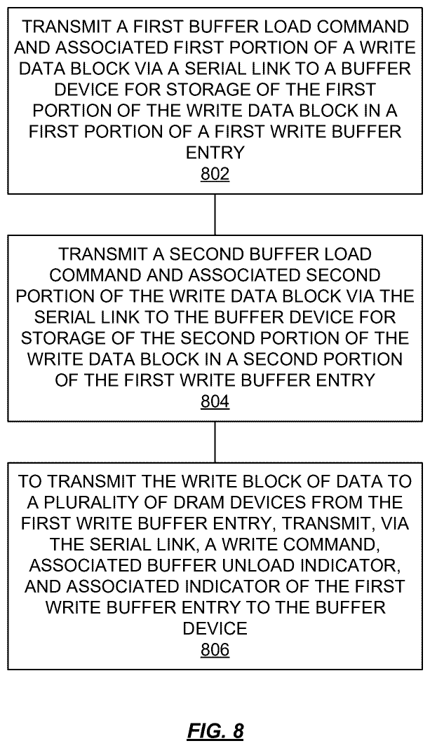

FIG. 8 is a flowchart illustrating a method of operating a controller. One or more steps illustrated in FIG. 8 may be performed by, for example, system 100, and/or its components. A first buffer load command and associated first portion of a write data block are transmitted via a serial link to a buffer device for storage of the first portion of the write data block in a first portion of a first write buffer entry (802). For example, controller 120 may transmit, via transmit link 141t, a first buffer load command (e.g., BLa1 of FIG. 3) and a first portion of a write data block (e.g., WDa1 of FIG. 3) for storage in a portion of write data entry 134a of write data buffer circuitry 134.

A second buffer load command and associated second portion of the write data block are transmitted via the serial link to the buffer device for storage of the second portion of the write data block in a second portion of the first write buffer entry (804). For example, controller 120 may transmit, via transmit link 141t, a second buffer load command (e.g., BLa2 of FIG. 3) and a second portion of the write data block (e.g., WDa2 of FIG. 3) for storage in a different than the first portion of write data entry 134a of write data buffer circuitry 134. To transmit the write block of data to a plurality of DRAM devices from the first write buffer entry, a write command associated buffer unload indicator, and associated indicator of the first write buffer entry are transmitted to the buffer device (806). For example, to write the coalesced data stored in write data entry 134a, controller 120 may transmit a write using buffer unload command, and associated indicators, to buffer device 130 in order to cause buffer device 130 to transmit a DRAM write command, address, and the write data from write data entry 134a to memory devices 110a-110c.

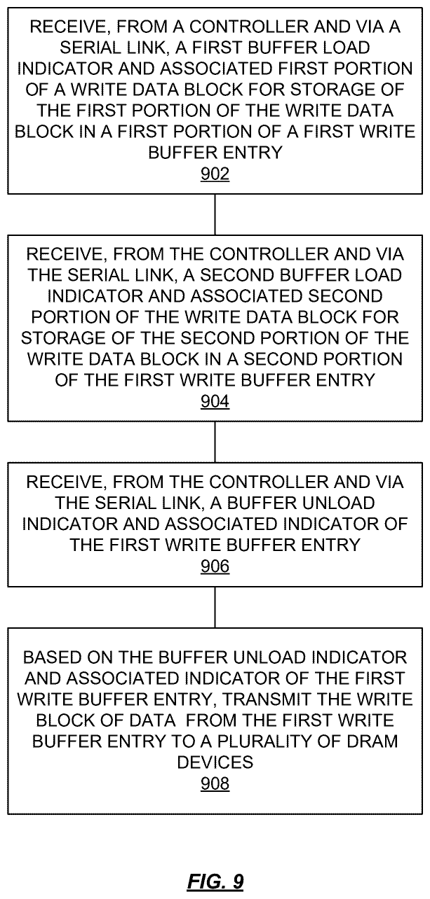

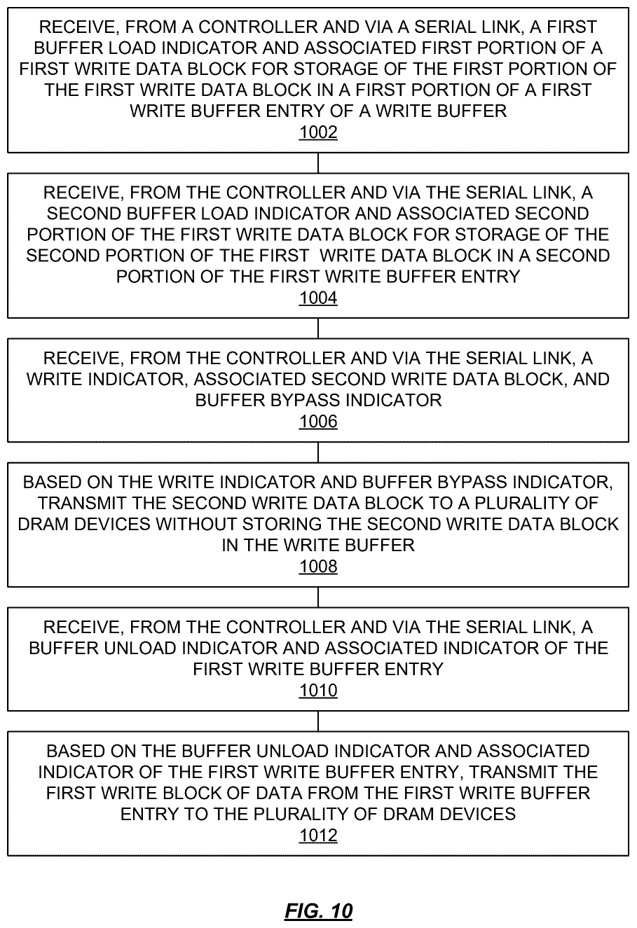

FIG. 9 is a flowchart illustrating a method of loading and unloading a write data buffer. One or more steps illustrated in FIG. 9 may be performed by, for example, system 100, and/or its components. From a controller and via a serial link, a first buffer load indicator and associated first portion of a write data block are received via a serial link for storage of the first portion of the write data block in a first portion of a first write buffer entry (902). For example, buffer device 130 may receive, from controller 120 via transmit link 141t, a first buffer load command (e.g., BLa1 of FIG. 3) and associated first portion (e.g., WDa1 of FIG. 3) of a write data block (e.g., WDa of FIG. 3) for storage in a first portion of write data entry 134a.

From the controller and via the serial link, a second buffer load indicator and associated second portion of the write data block are received via the serial link for storage of the second portion of the write data block in a second portion of the first write buffer entry (904). For example, buffer device 130 may receive, from controller 120 via transmit link 141t, a second buffer load command (e.g., BLa2 of FIG. 3) and associated second portion (e.g., WDa2 of FIG. 3) of the write data block (e.g., WDa of FIG. 3) for storage in a second portion of write data entry 134a.

From the controller and via the serial link, a buffer unload indicator and associated indicator of the first write buffer entry is received (906). For example, buffer device 130 may receive, from controller 120, a write using buffer unload command and an associated (or included) address/indicator of write data entry 134a (e.g., WR BUa of FIG. 3). Based on the buffer unload indicator and associated indicator of the first write buffer entry, the write block of data is transmitted from the first write buffer entry to a plurality of DRAM devices (908). For example, based on the write using buffer unload command an associated indicator(s), buffer device 130 may transmit a DRAM write command, DRAM address (e.g., DWRa CA of FIG. 3) and write data (WDa of FIG. 3) via channel interface 131 to memory devices 110a-110c.

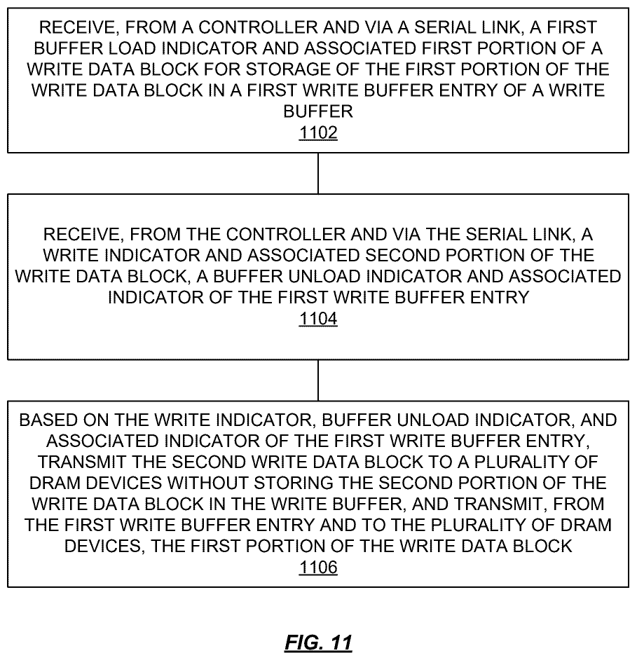

FIG. 10 is a flowchart illustrating a method of bypassing a write data buffer. One or more steps illustrated in FIG. 10 may be performed by, for example, system 100, and/or its components. From a controller and via a serial link, a first buffer load indicator and associated first portion of a first write data block is received for storage of the first portion of the first write data block in a first portion of a first write buffer entry of a write buffer (1002). For example, buffer device 130 may receive, from controller 120 via transmit link 141t, a first buffer load command and associated first portion of a write data block for storage in a first portion of write data entry 134a.

From the controller and via the serial link, a second buffer load indicator and associated second portion of the first write data block is received for storage of the second portion of the first write data block in a second portion of the first write buffer entry (1004). For example, buffer device 130 may receive, from controller 120 via transmit link 141t, a second buffer load command and associated second portion of the write data for storage in a second portion of write data entry 134a.

From the controller and via the serial link, a write indicator, associated second write data block, and buffer bypass indicator are received (1006). For example, controller 120 may transmit, via serial link 141t, a command/indicator to bypass write data buffer circuitry 134 and an associated write data burst. Based on the write indicator and buffer bypass indicator, the second write block of data is transmitted to a plurality of DRAM devices without storing the second write block of data in the write buffer (1008). For example, buffer device may, based on the command/indicator to bypass the associate write data, send deserialized write data from a single contiguous burst of write data directly to memory device 110a-110c via channel interface 131 without first being stored in write data buffer circuitry 134.

From the controller and via the serial link, a buffer unload indicator and associated indicator of the first write buffer entry is received (1010). For example, buffer device 130 may receive, from controller 120, a write using buffer unload command and an associated (or included) address/indicator of write data entry 134a. Based on the buffer unload indicator and associated indicator of the first write buffer entry, the write block of data is transmitted from the first write buffer entry to a plurality of DRAM devices (1012). For example, based on the write using buffer unload command an associated indicator(s), buffer device 130 may transmit a DRAM write command, DRAM address and write data via channel interface 131 to memory devices 110a-110c.

FIG. 11 is a flowchart illustrating a method of communicating mixing bypassed and buffered write data. One or more steps illustrated in FIG. 11 may be performed by, for example, system 100, and/or its components. From a controller and via a serial link, a first buffer load indicator and associated first portion of a write data block for storage of the first portion of the write data block in a first write buffer entry of a write buffer is received (1102). For example, buffer device 130 may receive, from controller 120 via transmit link 141t, a first buffer load command (e.g., BLa1 of FIG. 6) and associated first portion (e.g., WDa1 of FIG. 6) of a write data block (e.g., WDa of FIG. 6) for storage in a first portion of write data entry 134a.

From the controller and via the serial link, a write indicator and associated second portion of the write data block, a buffer unload indicator, and associated indicator of the first write buffer entry is received (1104). For example, buffer device 130 may receive, from controller 120 via transmit link 141t, a write with partial buffer unload command with an indicator of write data entry 134a (e.g., BUa1 of FIG. 6) and associated second portion (e.g., WDa2 of FIG. 6) of the write data block. Based on the write indicator, buffer unload indicator, and associated indicator of the first write buffer entry, the second write data block is transmitted to a plurality of DRAM devices without storing the second portion of the write data block in the write buffer and the first portion of the write data block is transmitted from the first write buffer entry to the plurality of DRAM devices (1106). For example, For example, based on the write with partial buffer unload and associated indicators, buffer device 130 may transmit a DRAM write command, DRAM address, write data that has not been stored in write data buffer circuitry 134 (e.g., WDa2 of FIG. 6), and write data from write data entry 134a (e.g., WDa1 of FIG. 6) via channel interface 131 to memory devices 110a-110c.

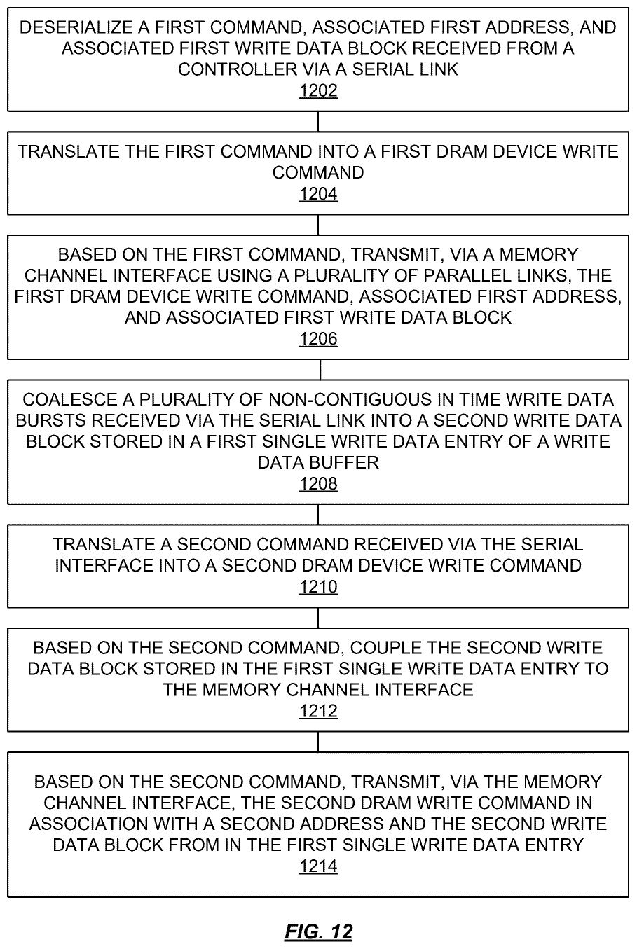

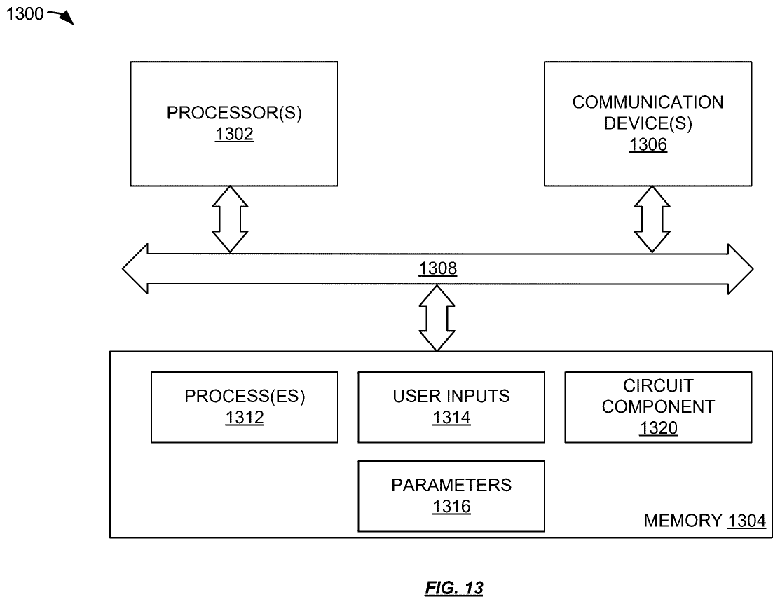

FIG. 12 is a flowchart illustrating a method of providing write commands and associated write data to a plurality of memory devices. One or more steps illustrated in FIG. 12 may be performed by, for example, system 100, and/or its components. A first command, associated first address, and associated first write data block received from a controller via a serial link are deserialized (1202). For example, buffer device 130 (and SERDES circuitry 136, in particular) may deserialize a first write command, associated first write address, and associated first write data block received from controller 120 via transmit link 141t.

The first command is translated into a first DRAM device write command (1204). For example, data buffer 130 (and control circuitry 135, in particular) may translate the deserialized first write command into a first DRAM device write command suitable for transmission via channel interface 131. Based on the first command and via a memory channel interface using a plurality of parallel links, the first DRAM device write command, associated first address, and associated first write data block are transmitted (1206). For example, buffer device 130 may transmit, via channel interface 131, the first DRAM device write command, deserialized first write address, and deserialized first write data to memory devices 110a-110c.

A plurality of non-contiguous in time write data bursts received via the serial link are coalesced into a second write data block stored in a first single write data entry of a write data buffer (1208). For example, based on a plurality of buffer load commands each associated with a respective plurality of portions of a second write data block that are received from controller 120 via transmit link 141t, buffer device 130 may coalesce the plurality of portions into the second write data block that is stored in write data entry 134a. A second command received via the serial interface is translated into a second DRAM device write command (1210). For example, data buffer 130 (and control circuitry 135, in particular) may translate a deserialized write with buffer unload command, received from controller 120 via transmit link 141t, into a second DRAM device write command suitable for transmission via channel interface 131.

Based on the second command, the second write data block stored in the first single write data entry is coupled to the memory channel interface (1212). For example, based on the write with buffer unload command, buffer device 130 may couple the contents of write data entry 134a to channel interface 131 to be transmitted as write data to memory devices 110a-110c. Based on the second command and via the memory channel interface, the second DRAM write command is transmitted, via the memory channel interface, in association with a second address and the second write data block from the first single write data entry (1214). For example, based on the write with buffer unload command, buffer device 130 may transmit, via channel interface 131, the second DRAM device write command, a second write address (e.g., received in association with the write with buffer unload command), and the contents of write data entry 134a to memory devices 110a-110c.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of memory system 100, and its components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

FIG. 13 is a block diagram illustrating one embodiment of a processing system 1300 for including, processing, or generating, a representation of a circuit component 1320. Processing system 1300 includes one or more processors 1302, a memory 1304, and one or more communications devices 1306. Processors 1302, memory 1304, and communications devices 1306 communicate using any suitable type, number, and/or configuration of wired and/or wireless connections 1308.

Processors 1302 execute instructions of one or more processes 1312 stored in a memory 1304 to process and/or generate circuit component 1320 responsive to user inputs 1314 and parameters 1316. Processes 1312 may be any suitable electronic design automation (EDA) tool or portion thereof used to design, simulate, analyze, and/or verify electronic circuitry and/or generate photomasks for electronic circuitry. Representation 1320 includes data that describes all or portions of memory system 100, and its components, as shown in the Figures.

Representation 1320 may include one or more of behavioral, register transfer, logic component, transistor, and layout geometry-level descriptions. Moreover, representation 1320 may be stored on storage media or communicated by carrier waves.

Data formats in which representation 1320 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 1314 may comprise input parameters from a keyboard, mouse, voice recognition interface, microphone and speakers, graphical display, touch screen, or other type of user interface device. This user interface may be distributed among multiple interface devices. Parameters 1316 may include specifications and/or characteristics that are input to help define representation 1320. For example, parameters 1316 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 1304 includes any suitable type, number, and/or configuration of non-transitory computer-readable storage media that stores processes 1312, user inputs 1314, parameters 1316, and circuit component 1320.

Communications devices 1306 include any suitable type, number, and/or configuration of wired and/or wireless devices that transmit information from processing system 1300 to another processing or storage system (not shown) and/or receive information from another processing or storage system (not shown). For example, communications devices 1306 may transmit circuit component 1320 to another system. Communications devices 1306 may receive processes 1312, user inputs 1314, parameters 1316, and/or circuit component 1320 and cause processes 1312, user inputs 1314, parameters 1316, and/or circuit component 1320 to be stored in memory 1304.

Implementations discussed herein include, but are not limited to, the following examples:
Example 1: A memory component, comprising: serial interface circuitry to receive commands, addresses, and data from a controller via a serial link; memory channel interface circuitry to communicate, using a plurality of parallel links, dynamic random access memory (DRAM) device commands, DRAM device addresses, and DRAM device write data with a plurality of DRAM devices; and first write data buffer circuitry to, based on a first plurality of commands communicated via the serial link, store first write data, the first write data to be communicated via the serial link by a plurality of non-contiguous in time data bursts each corresponding to respective ones of the first plurality of commands, the first write data buffer circuitry to also, based on a second command communicated via the serial link, provide the stored first write data to the memory channel interface circuitry for communication to the plurality of DRAM devices in association with a first DRAM device write command transmitted to the plurality of DRAM devices via the memory channel interface circuitry.
Example 2: The memory component of claim 1, further comprising: command translation circuitry to convert a second plurality of commands received via the serial interface circuitry to a first plurality of DRAM device commands transmitted via the memory channel interface circuitry.
Example 3: The memory component of claim 2, wherein the first plurality of commands are not converted by the command translation circuitry into DRAM device commands.
Example 4: The memory component of claim 1, wherein the controller includes second write data buffer circuitry.
Example 5: The memory component of claim 4, wherein the first write data buffer circuitry and the second write data buffer circuitry have equivalent write command data capacity.
Example 6: The memory component of claim 1, wherein the plurality of DRAM devices are stacked with an integrated circuit die that includes one or more of the serial interface circuitry, the memory channel interface circuitry, and the first write data buffer circuitry.
Example 7: The memory component of claim 1, wherein the plurality of DRAM devices are disposed on a module with an integrated circuit that includes one or more of the serial interface circuitry, the memory channel interface circuitry, and the first write data buffer circuitry.
Example 8: A memory component, comprising: serializer/deserializer (SERDES) circuitry receive commands, addresses, and write data from a controller via a first serial link and to transmit read data via a second serial link; memory channel interface circuitry to communicate, using a plurality of parallel links, dynamic random access memory (DRAM) device commands, DRAM device addresses, DRAM device write data, and DRAM device read data with a plurality of DRAM devices; and a first write data buffer having a first plurality of write data entries, the first write data buffer to coalesce a plurality of non-contiguous in time write data bursts received via the first serial link into a first write data block that is stored in a single write data entry of the first plurality of write data entries, the first write data buffer to also, based on a first command received via the first serial link, couple the first write data block stored in the single write data entry to the memory channel interface circuitry to be transmitted to the plurality of DRAM devices as DRAM device write data.
Example 9: The memory component of claim 8, further comprising: command translation circuitry to convert a first write command received via the first serial link to a first DRAM device write command that is associated with the first write data block and is transmitted to the plurality of DRAM devices via the memory channel interface circuitry.
Example 10: The memory component of claim 9, wherein the first write data buffer is to coalesce the plurality of non-contiguous in time write data bursts into the first write data block that is stored in the single write data entry of the first plurality of write data entries based on a plurality of write buffer commands received via the first serial link that are associated with respective ones of the plurality of non-contiguous in time write data bursts.
Example 11: The memory component of claim 9, wherein the plurality of write buffer commands are not converted to DRAM device commands that are to be transmitted to the plurality of DRAM devices via the memory channel interface circuitry.
Example 12: The memory component of claim 11, wherein the controller includes a second write data buffer having a second plurality of write data entries.
Example 13: The memory component of claim 12, wherein each of the first plurality of write data entries and each of the second plurality of write data entries have equal write data sizes.
Example 14: The memory component of claim 13, wherein the first plurality of write data entries each correspond to respective ones of the second plurality of write data entries.
Example 15: A method of operating a memory component, comprising: deserializing commands, addresses, and write data received from a controller via a first serial link; communicating, via a memory channel interface using a plurality of parallel links, dynamic random access memory (DRAM) device commands, DRAM device addresses, and DRAM device write data, that are based on the commands, addresses, and write data received from the controller via the first serial link; coalescing a plurality of non-contiguous in time write data bursts received via the first serial link into a first write data block that is stored in a first single write data entry of a first plurality of write data entries of a first write data buffer; based on a first command received via the first serial link, coupling the first write data block stored in the first single write data entry to the memory channel interface; and transmitting, by the memory channel interface, the first write data block to the plurality of DRAM devices as DRAM device write data.
Example 16: The method of claim 15, further comprising: translating a first write command received via the first serial link to a first DRAM device write command that is associated with the first write data block; and transmitting first DRAM device write command to the plurality of DRAM devices via the memory channel interface.
Example 17: The method of claim 16, further comprising: receiving a plurality of write buffer commands via the first serial link that are associated with respective ones of the plurality of non-contiguous in time write data bursts.
Example 18: The method of claim 17, wherein the controller includes a second write data buffer having a second plurality of write data entries and the first write data block is stored in a second single write data entry of the second plurality of write data entries prior to being communicated via the plurality of non-contiguous in time write data bursts.
Example 19: The method of claim 18, wherein the plurality of DRAM devices are included in a stack of integrated circuit die.
Example 20: The method of claim 18, wherein the plurality of DRAM devices are disposed on a memory module.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A memory component, comprising:
serial interface circuitry to receive commands, addresses, and data from a controller via a serial link;
memory channel interface circuitry to communicate, using a plurality of parallel links, dynamic random access memory (DRAM) device commands, DRAM device addresses, and DRAM device write data with a plurality of DRAM devices; and
first write data buffer circuitry to, based on a first plurality of commands communicated via the serial link, store first write data, the first write data to be communicated via the serial link by a plurality of non-contiguous in time data bursts each corresponding to respective ones of the first plurality of commands, the first write data buffer circuitry to also, based on a second command communicated via the serial link, provide the stored first write data to the memory channel interface circuitry for communication to the plurality of DRAM devices in association with a first DRAM device write command transmitted to the plurality of DRAM devices via the memory channel interface circuitry.

2. The memory component of claim 1, further comprising:
command translation circuitry to convert a second plurality of commands received via the serial interface circuitry to a first plurality of DRAM device commands transmitted via the memory channel interface circuitry.

3. The memory component of claim 2, wherein the first plurality of commands are not converted by the command translation circuitry into DRAM device commands.

4. The memory component of claim 1, wherein the controller includes second write data buffer circuitry.

5. The memory component of claim 4, wherein the first write data buffer circuitry and the second write data buffer circuitry have equivalent write command data capacity.

6. The memory component of claim 1, wherein the plurality of DRAM devices are stacked with an integrated circuit die that includes one or more of the serial interface circuitry, the memory channel interface circuitry, and the first write data buffer circuitry.

7. The memory component of claim 1, wherein the plurality of DRAM devices are disposed on a module with an integrated circuit that includes one or more of the serial interface circuitry, the memory channel interface circuitry, and the first write data buffer circuitry.

8. A memory component, comprising:
serializer/deserializer (SERDES) circuitry receive commands, addresses, and write data from a controller via a first serial link and to transmit read data via a second serial link;
memory channel interface circuitry to communicate, using a plurality of parallel links, dynamic random access memory (DRAM) device commands, DRAM device addresses, DRAM device write data, and DRAM device read data with a plurality of DRAM devices; and
a first write data buffer having a first plurality of write data entries, the first write data buffer to coalesce a plurality of non-contiguous in time write data bursts received via the first serial link into a first write data block that is stored in a single write data entry of the first plurality of write data entries, the first write data buffer to also, based on a first command received via the first serial link, couple the first write data block stored in the single write data entry to the memory channel interface circuitry to be transmitted to the plurality of DRAM devices as DRAM device write data.

9. The memory component of claim 8, further comprising:
command translation circuitry to convert a first write command received via the first serial link to a first DRAM device write command that is associated with the first write data block and is transmitted to the plurality of DRAM devices via the memory channel interface circuitry.

10. The memory component of claim 9, wherein the first write data buffer is to coalesce the plurality of non-contiguous in time write data bursts into the first write data block that is stored in the single write data entry of the first plurality of write data entries based on a plurality of write buffer commands received via the first serial link that are associated with respective ones of the plurality of non-contiguous in time write data bursts.

11. The memory component of claim 9, wherein the plurality of write buffer commands are not converted to DRAM device commands that are to be transmitted to the plurality of DRAM devices via the memory channel interface circuitry.

12. The memory component of claim 11, wherein the controller includes a second write data buffer having a second plurality of write data entries.

13. The memory component of claim 12, wherein each of the first plurality of write data entries and each of the second plurality of write data entries have equal write data sizes.

14. The memory component of claim 13, wherein the first plurality of write data entries each correspond to respective ones of the second plurality of write data entries.

15. A method of operating a memory component, comprising:
deserializing commands, addresses, and write data received from a controller via a first serial link;
communicating, via a memory channel interface using a plurality of parallel links, dynamic random access memory (DRAM) device commands, DRAM device addresses, and DRAM device write data, that are based on the commands, addresses, and write data received from the controller via the first serial link ;
coalescing a plurality of non-contiguous in time write data bursts received via the first serial link into a first write data block that is stored in a first single write data entry of a first plurality of write data entries of a first write data buffer;
based on a first command received via the first serial link, coupling the first write data block stored in the first single write data entry to the memory channel interface; and
transmitting, by the memory channel interface, the first write data block to the plurality of DRAM devices as DRAM device write data.

16. The method of claim 15, further comprising:
translating a first write command received via the first serial link to a first DRAM device write command that is associated with the first write data block; and
transmitting first DRAM device write command to the plurality of DRAM devices via the memory channel interface.

17. The method of claim 16, further comprising:
receiving a plurality of write buffer commands via the first serial link that are associated with respective ones of the plurality of non-contiguous in time write data bursts.

18. The method of claim 17, wherein the controller includes a second write data buffer having a second plurality of write data entries and the first write data block is stored in a second single write data entry of the second plurality of write data entries prior to being communicated via the plurality of non-contiguous in time write data bursts.

19. The method of claim 18, wherein the plurality of DRAM devices are included in a stack of integrated circuit die.

20. The method of claim 18, wherein the plurality of DRAM devices are disposed on a memory module.
